(19) United States
(12) Patent Application Publication
(10) Pub. No.: US 2008/0283668 A1
(43) Pub. Date: Nov. 20, 2008

(54) Composite material structure for aircraft fuselage and process for manufacturing it

(75) Inventors: Alberto Ramon Martinez Cerezo, Madrid (ES); Yolanda Miguez Charines, Madrid (ES); Javier Jordan Carnicero, Madrid (ES); Julian Sanchez Fernandez, Madrid (ES)

Correspondence Address: LADAS & PARRY LLP, 26 WEST 61ST STREET, NEW YORK, NY, 10023, US

(73) Assignee: AIRBUS ESPANA, S.L.

(21) Appl. No.: 11/731,793

(22) Filed: Mar. 30, 2007

(30) Foreign Application Priority Data
Jan. 30, 2007 (ES) PCT/ES07/70022

(51) Int. Cl. B64C 1/00

(52) U.S. Cl. 244/133

(57) ABSTRACT

The present invention provides a closed composite material structure for aircraft fuselage shaped on a male jig from which it can be separated in a certain direction, said structure comprising a single outer panel and a plurality of inner longitudinal stiffeners integrated in said panel, such that the expansion coefficient of the male jig is greater than the expansion coefficient of the composite material of the structure, thus being able to remove the already manufactured structure, formed by the panel and the integrated inner stiffeners, in a single operation. The present invention further provides a process for manufacturing such a closed structure.

### FIELD OF THE INVENTION

The present invention relates to a single piece, closed composite material structure for aircraft fuselage and to the process for manufacturing such a structure.

### BACKGROUND OF THE INVENTION

The structures used in aeronautic fuselages comprise an outer panel, stiffeners and/or inner stringers. Since weight is a fundamental aspect in the aeronautic industry, the structures used in optimized aeronautic fuselages are manufactured in composite materials, these composite material structures thus prevailing over the more traditional metallic structures.

In the process for optimizing this type of structures, maximal weight reduction and the integration of a larger number of individual parts into larger parts are sought so as to reduce both the duration of the manufacturing process and the handling and assembly of smaller elements.

The application of the previous aspects to aeronautic fuselages leads to integrating the outer panels with their stiffeners in the smallest possible number of operations. Examples of this are found in documents EP 1151856, where the previously cured panels are assembled on each of the outer panels, and U.S. Pat. No. 5,242,523, where the crossed framework of composite material stiffeners is assembled in several operations on the outer panels forming the structure. In these cases, the panels together with their stiffeners are manufactured in several successive operations, the addition of parts to subsequently join these panels to one another with joints ensuring the tightness between panels further being necessary.

The object of the present invention is a composite material structure for aircraft fuselage solving the drawbacks of the prior art, as well as a process for manufacturing such a structure.

### SUMMARY OF THE INVENTION

The present invention therefore provides a closed composite material structure for aircraft fuselage formed on a male jig from which it can be separated in a certain direction, said structure comprising a single outer panel and a plurality of inner longitudinal stiffeners integrated in said panel, such that the expansion coefficient of the male jig is greater than the expansion coefficient of the composite material of the structure, thus being able to remove the already manufactured structure, formed by the panel and the integrated inner stiffeners, in a single operation.

The present invention further proposes a process for manufacturing such a closed structure comprising the following steps:
a) arranging the stiffeners on the male jig;
b) laminating the composite material on the surface formed by the male jig and the stiffeners to form the outer panel;
c) placing a hold-down plate on the outer surface of the laminated composite material;
d) placing the necessary remaining auxiliary elements for the autoclave curing of the composite materials used;
e) curing the closed structure in high temperature and pressure conditions inside an autoclave;
f) separating the closed structure from the male jig according to the suitable direction of the separation direction.

Other features and advantages of the present invention will emerge from the following detailed description of an illustrative embodiment of its object in relation to the attached figures.

### DESCRIPTION OF THE DRAWINGS

FIG. 1 shows a perspective view of a closed composite material structure for aircraft fuselage according to the present invention.

FIG. 2 shows a detailed sectioned view of the panel and of a stiffener of a closed composite material structure according to the present invention.

FIG. 3 shows a cross-section of a closed composite material structure arranged on a male jig, according to the present invention.

FIG. 4 shows a detailed sectioned view of the male jig shaping the closed composite material structure according to the present invention.

FIG. 5 shows a sectioned view of the process for manufacturing a closed composite material structure according to the present invention.

FIG. 6 shows a cross-section of a closed composite material structure arranged on a male jig, according to the present invention, after the curing process.

FIG. 7 shows a detailed sectioned view of the male jig shaping the closed composite material structure according to the present invention, after the curing process.

FIG. 8 shows a view of the removal of the male jig from the closed composite material structure according to the present invention.

FIG. 9 shows a view of an implementation of the male jig according to a first embodiment of the invention.

FIG. 10 shows a view of an implementation of the male jig according to a second embodiment of the invention.

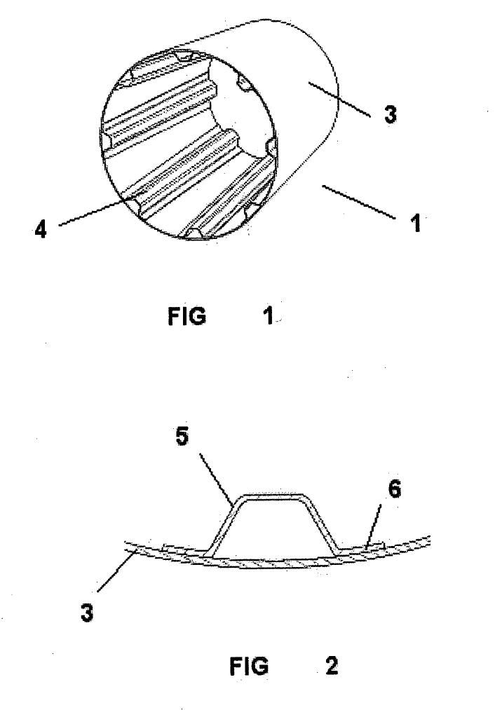

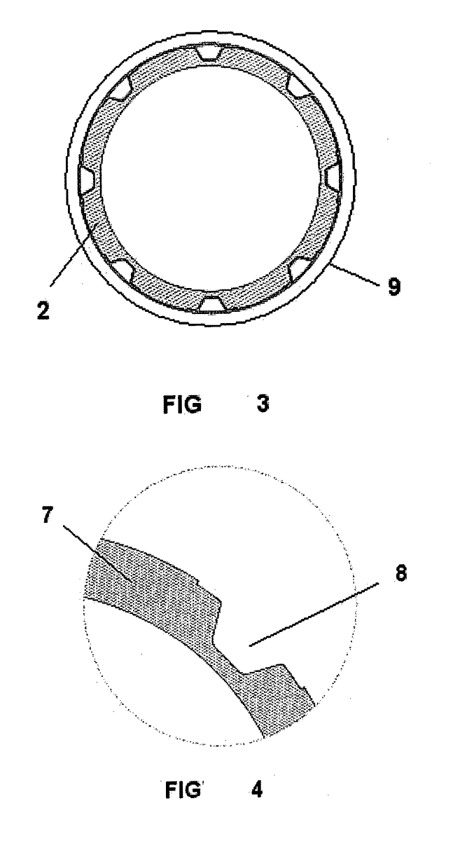

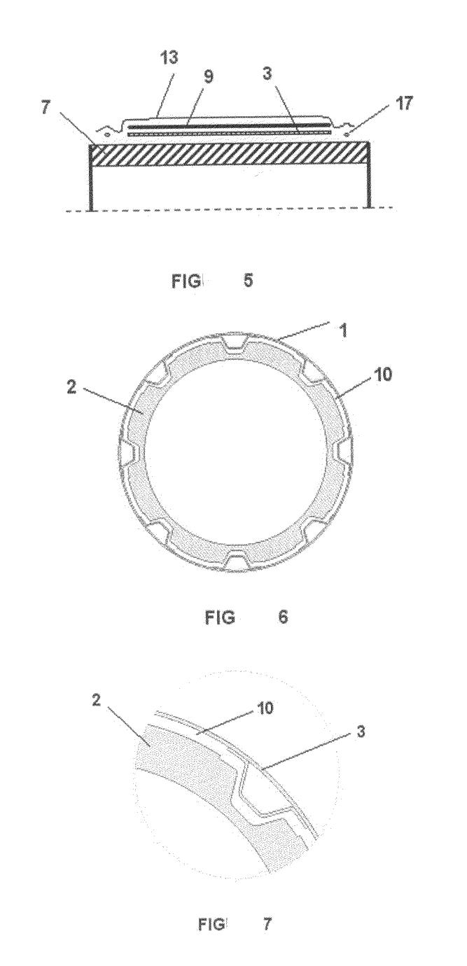

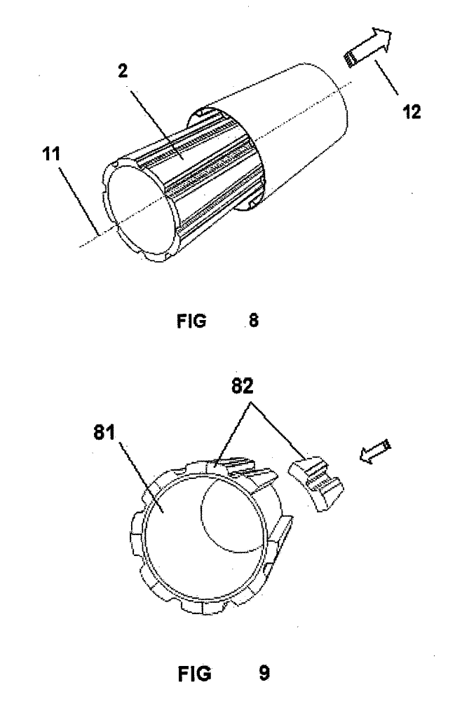

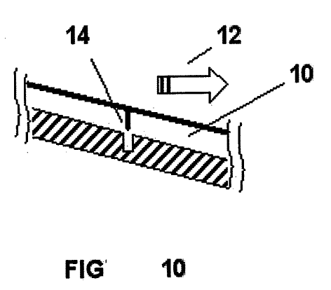

### DETAILED DESCRIPTION OF THE INVENTION

The present invention proposes a closed structure 1 for aircraft fuselage manufactured in composite material comprising an outer panel 3 and a plurality of inner longitudinal stiffeners 4 integrated on said panel 3. These stiffeners 4 have a honeycomb shape, preferably an omega (Ω) shape, each of which comprises in turn webs 5, which are parts of the stiffener 4 separated from the panel 3, and legs 6, which are the parts of the stiffener 4 joined to the panel 3.

The closed structure 1 will preferably have a cylindrical or frustoconical shape.

The closed composite material structure 1 is shaped on a leak-tight male jig 2 in turn comprising a body 7 and slots 8, such that the material of the male jig 2 has a thermal expansion coefficient that is greater than that of the composite material forming the structure 1.

The outer surface of the male jig 2 has a shape similar to the inner surface of the closed structure 1, such that the slots 8 of the male jig 2 house the webs 5 of the stiffeners 4.

The closed structure 1 must have a shape allowing its separation from the male jig 2 in a certain direction 11, and in direction 12.

After the curing process, a clearance 10 occurs which allows removing the shaped structure 1 from the male jig 2, in direction 11 and in direction 12. The clearance 10 which occurs after the curing process can be observed in FIG. 7, the size of the structure 1 remaining greater than the size of the male jig 2 after the curing process (see FIG. 6).

The present invention further proposes a process for manufacturing a closed composite material structure 1 comprising the following steps:
a) sequentially arranging the stiffeners 4 on the slots 8 of the male jig 2, such that the webs 5 of the stiffeners 4 are in the slots 8 and the legs 6 are supported on the outer surface of the male jig 2;
b) laminating the composite material on the surface formed by the male jig 2 and the stiffeners 4, to form the outer panel 3 of the closed structure 1;
c) placing a hold-down plate 9 on the outer surface of the outer panel 3 to provide surface quality to said surface;
d) placing the necessary remaining auxiliary elements 13 for the autoclave curing of the composite materials used, there being gaskets 17 between them;
e) curing the closed structure 1 inside the autoclave in high pressure and temperature conditions, this process including in turn the following steps:
   i. temperature increase of the assembly formed by the male jig 2 and the composite material of the closed structure 1;
   ii. expansion of the male jig 2 and of the composite material of the closed structure 1;
   iii. polymerization of the composite material of the closed structure 1 due to the effect of pressure and temperature;
   iv. cooling of the assembly formed by the closed structure 1 and the male jig 2 once the polymerization has concluded, such that the closed structure 1 reaches it definitive geometry and the male jig 2 recovers its initial geometry;
f) separating the closed structure 1 from the male jig 2 according to the suitable direction 12 of the separation direction 11.

A closed structure 1, the geometry of which is greater than the initial geometry and having a clearance 10 with respect to the taping and curing male jig 2, is obtained after this process.

The closed structure 1 is separated from the male jig 2 in a manner parallel to the longitudinal separation direction 11, and in direction 12, according to its geometric features and aided by the clearance 10 generated in the curing process.

The design of the stiffeners 4, the skin 3 and the jig 2 will be such that there are no mechanical interferences during the demolding process, further considering the clearances 10 generated in the process. In the event of interferences occurring in the design process, if said interference is less than the local clearance 10 generated in the process for curing the closed structure 1, said closed structure 1 can also be demolded.

According to another preferred embodiment of the invention, at least one inner element 14 inside the outer panel 3 can be introduced in the closed structure 1, which element is not designed according to the longitudinal separation direction 11. The removal of the closed structure 1 according to the longitudinal separation direction 11 is then achieved if the size of this inner element 14 is smaller than the clearance 10 generated in the curing process.

The hold-down plates 9 provide the closed structure 1 with the required surface quality.

According to another variant of the invention, the male jig 2 can be formed by a leak-tight tubular element 81 on which a series of detachable elements 82 completely or partially shaping the inner surface of the closed structure 1 are placed.

Those modifications comprised within the scope defined by the following claims can be introduced in the preferred embodiments which have just been described.

1. A closed composite material structure (1) for aircraft fuselage shaped on a male jig (2), said structure (1) comprising an outer panel (3) and a plurality of longitudinal stiffeners (4) inside said outer panel (3), characterized in that the expansion coefficient of the male jig (2) is greater than the expansion coefficient of the composite material of the structure (1), a clearance (10) which allows separating the structure (1) from the male jig (2) being generated between the outer panel (3) and the male jig (2) in the process for curing the composite material of the structure (1).

2. A closed structure (1) according to claim 1, characterized in that the male jig (2) comprises a leak-tight tubular element (81) on which a plurality of detachable elements (82) are placed.

3. A closed structure (3) according to claim 1, characterized in that the outer panel (3) comprises in its inner surface at least one element (14) with a size smaller than the clearance (10) generated in the process for curing the composite material of the structure (1).

4. A closed structure (3) according to claim 1, characterized in that the stiffeners (4) comprise webs (5) separated from the panel (3) and legs (6) joined to the panel (3).

5. A closed structure (3) according to claim 1, characterized in that the stiffeners (4) have a honeycomb shape.

6. A closed structure (3) according to claim 1, characterized in that the stiffeners (4) have an omega (Ω) shape.

7. A closed structure (3) according to claim 1, characterized in that the structure (1) has a shape such as a cylindrical shape.

8. A closed structure (3) according to claim 1, characterized in that the structure (1) has a shape such as a frustoconical shape.

9. A process for manufacturing a closed composite material structure (1) for aircraft fuselage comprising the following steps:
a) sequentially arranging the stiffeners (4) on the male jig (2);
b) laminating the composite material on the surface formed by the male jig (2) and the stiffeners (4) to form the outer panel (3) of the closed structure 1;
c) placing a hold-down plate (9) on the outer surface of the outer panel (3);
d) placing the necessary remaining auxiliary elements (13) for the autoclave curing of the composite materials used;
e) curing the closed structure (1) inside the autoclave in high pressure and temperature conditions;
f) separating the closed structure (1) from the male jig (2) according to a separation direction (11) and direction (12).
